(19) United States
(12) Patent Application Publication
(10) Pub. No.: US 2011/0095192 A1
(43) Pub. Date: Apr. 28, 2011

(54) Method to increase dynamic range of segmented non-linear devices

(76) Inventor: Kurtis F. Johnson, Tallahassee, FL (US)

(21) Appl. No.: 12/925,662

(22) Filed: Oct. 26, 2010

Related U.S. Application Data
(60) Provisional application No. 61/279,820, filed on Oct. 26, 2009.

(51) Int. Cl. G01T 1/29

(52) U.S. Cl. 250/370.1

(57) ABSTRACT

A method for increasing the dynamic range of non-linear devices, such as a SiPM. By rendering the incoming flux of photos non-uniform, a significant increase in the useful dynamic range can be achieved. The desired distortion of the incoming flux can be achieved in a variety of ways. These include simple non-focused lenses, prisms, interference films, mirrors, and attenuating films. Virtually any device which distorts the incoming flux will increase the dynamic range of the SiPM and combinations may be used to tailor the response to a desired application.

### CROSS-REFERENCES TO RELATED APPLICATIONS

Pursuant to the provisions of 37 C.F.R. §1.53(c), this is a non-provisional patent application claiming the benefit of an earlier filed provisional application. The provisional application was filed on Oct. 26, 2009. It was assigned Ser. No. 61/279,820 and it listed the same inventor.

### STATEMENT REGARDING FEDERALLY SPONSORED RESEARCH OR DEVELOPMENT

Not Applicable.

### MICROFICHE APPENDIX

Not Applicable.

### BACKGROUND OF THE INVENTION

1. Field of the Invention

This invention relates to the field of pixelized, non-linear detectors, sensors or transducers. More specifically, the invention comprises a method to increase the dynamic range of a solid-state monolithic device such as a silicon photomultiplier beyond what is presently possible.

2. Description of the Related Art

Although the present inventive method can be applied to a wide range of non-linear detectors, sensors, or transducers, this explanation will focus on the specific example of a Silicon photomultiplier. The reader should bear in mind that the scope of the invention lies beyond the examples provided, however.

Silicon photomultipliers (Often referred to as a “SiPM” or “MPPC”) are relatively new devices. These detectors are on the cutting edge of a variety of applications in physics and medical imaging. A SiPM excels at detecting extremely weak light at the photon counting level. Simple operation and extreme sensitivity characterize the SiPM. It is suitable for a wide variety of fields including fluorescence analysis, fluorescence lifetime measurement, biological flow cytometry, confocal microscopes, biochemical sensors, bioluminescence analysis, and single molecular detection.

In contrast to conventional photomultipliers, the SiPM is not sensitive to magnetic fields. Thus, a SiPM can be used as a detector for positron emission tomography (“PET scans”) in a device which is integrated into an MRI machine. The SiPM can perform its function even while immersed in the MRI machine's powerful magnetic field. The SiPM also has applications in high-energy physics experiments because of its room-temperature operation, insensitivity to magnetic fields, low bias voltage requirements, high speed of response, single photon sensitivity, and small size.

A SiPM is capable of detecting a single photon. It is constructed as a pixel array of avalanche photo diodes (“APD”) on a common silicon substrate. Each pixel in the array can range from 20 to 100 micrometers, meaning that their density can exceed 1,000 per square millimeter, at present. Although each pixel in a SiPM operates in “Geiger” mode (meaning that once the sensitivity threshold of a given pixel is exceeded it fires and additional photon strikes will not produce additional output for that pixel), the SiPM as a whole is an analog device, since the outputs of all the pixels are connected in parallel.

The sensitivity of each pixel in existing SiPM devices is in many respects advantageous. However, in some respects the “Geiger” mode of operation is limiting. The biggest limitation is that fact that a single pixel in a SiPM device is incapable of distinguishing between a single photon and more than one photon. The ability to make such a distinction is referred to as “dynamic range.”

It is the connection of many pixels in parallel which allows for dynamic range; the more pixels in the device, the greater the dynamic range. At present, the dynamic range of a SiPM is limited by the number of pixels which the manufacturer can fabricate onto a chip. As will be shown below, at present the dynamic range is limited to about 3 effective photons per pixel. The present invention proposes devices and methods which can extend the dynamic range of a SiPM (or other non-linear device) beyond that which is presently possible. The inventive method accomplishes this objective without having to alter the physical structure of the SiPM.

### BRIEF SUMMARY OF THE INVENTION

The present invention is a method for increasing the dynamic range of a non-linear device such as a SiPM. For the case of a SiPM, the invention renders the incoming flux of photons non-uniform. This creates a significant increase in the useful dynamic range. The desired re-distribution of the incident flux can be achieved in a variety of ways. These include simple non-focusing lenses, prisms, interference films, mirrors, and attenuating films. Virtually any device which distorts the incident flux will increase the dynamic range of the SiPM, and combinations of them may be used to tailor the response to a desired application.

### BRIEF DESCRIPTION OF THE SEVERAL VIEWS OF THE DRAWINGS

FIG. 1 is a plot of the fraction of pixels firing versus the number of effective photons per pixel for multiple configurations including the prior art and several implementations of the present inventive method.

FIG. 2 is a perspective view of one method of redistributing photon flux over the surface of a SiPM.

FIG. 3 is a perspective view of a second method of redistributing photon flux over the surface of a SiPM.

### REFERENCE NUMERALS IN THE DRAWINGS

10 silicon photomultiplier
12 pixel array
14 neutral density filter
16 perforation
18 lens
20 focus zone
22 penumbra

### DETAILED DESCRIPTION OF THE INVENTION

Although the conventional operation of SiPM's is understood by those skilled in the art, the reader may benefit from some basic explanation of this operation. An “idealized” SiPM would be 100% efficient. Its inter-pixel gain variation would be negligible. The incoming flux of photons would be spatially uniform. The device would also be able to detect a photon striking anywhere in the active area. These assumptions do not hold perfectly true, but they provide a good baseline for comparison.

As stated previously, each pixel of a SiPM is a Geiger-mode device, meaning that when one or more photons strike the active area the pixel “fires” and releases an electrical charge to the output. The amount of charge released is not proportional to the number of photons triggering the pixel. In other words, more than one photon striking the pixel will cause the same amount of charge to be released as one photon.

However, all the outputs of all the pixels are typically electrically connected in parallel. Thus, the sum of the outputs will be proportional to the fraction of the pixels which fire. The controlling process is therefore the Poisson distribution of the photons striking the pixels. If λ is the value for the average number of photons striking a pixel, then the probability for 0, 1, 2, . . . n photons striking a given pixel may be written as:

$$P ( n ) = \frac{{λ}^{n} {e}^{- λ}}{n !}$$

The probability of a given pixel NOT firing is P(0,λ)=e^{-λ}. The Poisson distribution is a normalized probability distribution, thus the probability to fire of any particular pixel may then be expressed as 1−e^{-λ}.

Actual SiPM's do not have a uniformly photo-sensitive surface. A portion of the surface is insensitive to photons. Manufacturers sometimes list a geometric “fill factor,” which is the fraction of photon-sensitive surface area to the whole. Devices may have larger or smaller fill factors depending on the details of their construction. Thus, 1000 photons falling onto the surface of a SiPM with a fill factor of 0.6 have the same effect as 600 photons onto a SiPM having a fill factor of 1.0 (assuming the same number of pixels).

Even the photo-sensitive area has a quantum efficiency (QE) that is less than 1.0. The effect of QE on the response of a pixel is such that if n photons are incident upon a pixel, the pixel will respond (on average) with the probability of n*QE photons.

In order to eliminate the effects of fill factor and quantum efficiency in the comparison of SiPM's having different constructions, it is useful to define the term “effective photons.” “Effective photons” is defined to be the (number of incident photons)*(geometric fill factor)*QE. The symbol λ will henceforth be used to designate the number of effective photos per pixel.

The actual numeric value of the correction from real to effective photons is not important for many applications. However, for those cases where the conversion is important, the number may be determined using a calibrated photon source.

The present inventive method dramatically improves the dynamic range of a device such as a SiPM. The term “dynamic range” is defined as the ratio of the number of effective photons necessary to fire one pixel to the average number necessary to fire 95% of the pixels. From the definition of “effective photon” it follows that a single effective photon suffices to fire a single pixel in an unaltered SiPM. The present invention proposes adding an interceding absorber in between the photon source and the SiPM's pixel array. The presence of this interceding absorber significantly alters the dynamic range of the SiPM.

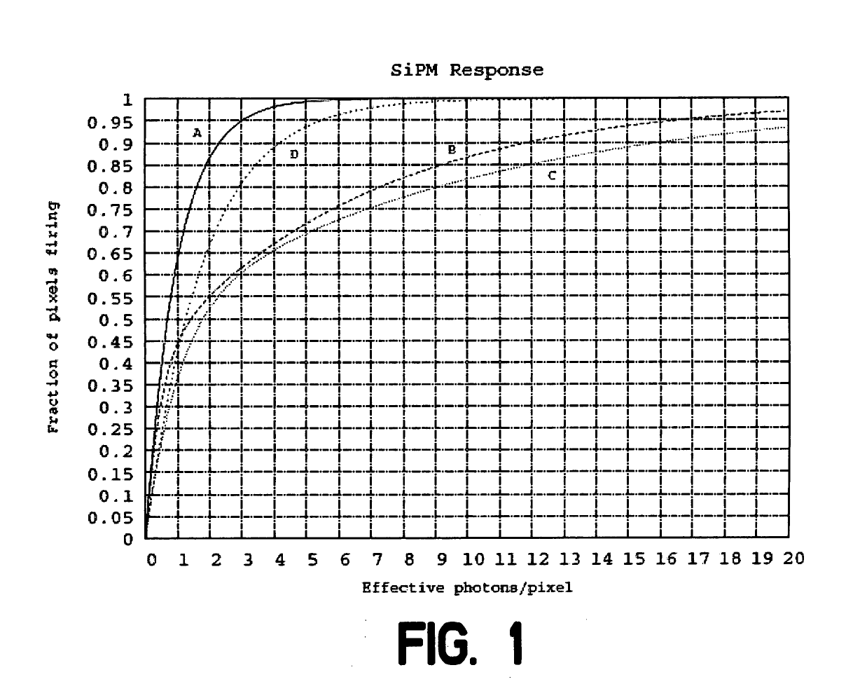

FIG. 1 displays four different plots of the fraction of pixels firing versus the effective photos per pixel. Curve “A” represents the idealized SiPM described above, which is simply the cumulative distribution function for e^{-λ}. It can be seen that at an effective photon intensity of 3 (λ=3) the output is at 95% of full scale. All higher photon densities are compressed into the final 5% of available output. This final 5% may or may not be adequate for the measurement task at hand, but it provides a simple reference for discussion and comparison of the prior art with the proposed inventive method.

The inventive method described herein expands the dynamic range by altering the incident photon flux such that some pixels in the SiPM array are illuminated more or less intensely than others. This variable illumination can be accomplished using lenses or lens-like devices (focusing and non-focusing), absorbers, filters, interference films, and the like. The inventor is not aware of any term which would encompass this entire class of possibilities. Thus, the term “interceding absorber” will be used to generally describe these devices. The reader should note that the term includes optical devices having very little transmission loss, so the inclusion of the word “absorber” should not be viewed as unduly limiting. Whatever device is used, the interceding absorber should have non-uniform optical transmission. That is, it should project a non-uniform photon flux onto the pixel array of the SiPM.

The reader should also note that lenses have in the past been used in combination with SiPM's, but always with the object of increasing the light gathering power of the device. Lenses or other interceding absorbers used in the present inventive method are provided instead to create non-uniform illumination of the active area of the SiPM.

Those skilled in the art will realize that many different methods could be used to create a non-uniform illumination of a SiPM pixel array. However, the reader's understanding may be furthered by the presentation of two specific embodiments.

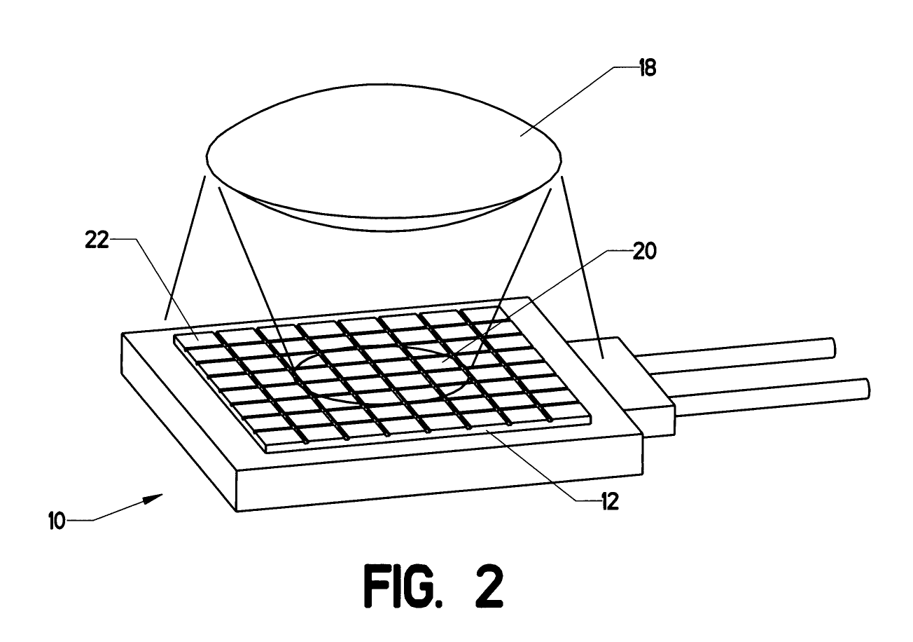

The first such embodiment includes the use of an interceding absorber having low transmission losses. A good example of a low-loss interceding absorber is an optical lens. FIG. 2 depicts an arrangement using a lens. Lens 18 is placed a distance away from pixel array 12 of silicon photomultiplier 10. The lens is not focused to a point. Instead, it is positioned to produce a focus zone 20 (over a region) and a penumbra 22.

In this example, 91% of the photons are diverted onto only 40% of the available pixel area (with the remaining 60% of the pixels receiving only 9% of the photons). The threshold flux for firing a single pixel is not changed by this arrangement. The result is shown as Curve B in FIG. 1. The firing fraction is given by the expression:

0.4(1−e^{-0.91λ/0.4})+0.6(1−e^{-0.09λ/0.6})

The reader will observe that the 95% point in the dynamic range has shifted from λ=3 in Curve A to λ=16 in Curve B. This is a greater than five-fold increase, equivalent to the natural dynamic range of a SiPM with more than five times the pixel count.

A second example considers the use of an interceding absorber having a higher loss rate. If photons are plentiful and the lower end condition can be relaxed, one can produce similar results with photon absorbing configurations (which may in fact be simpler and cheaper to implement).

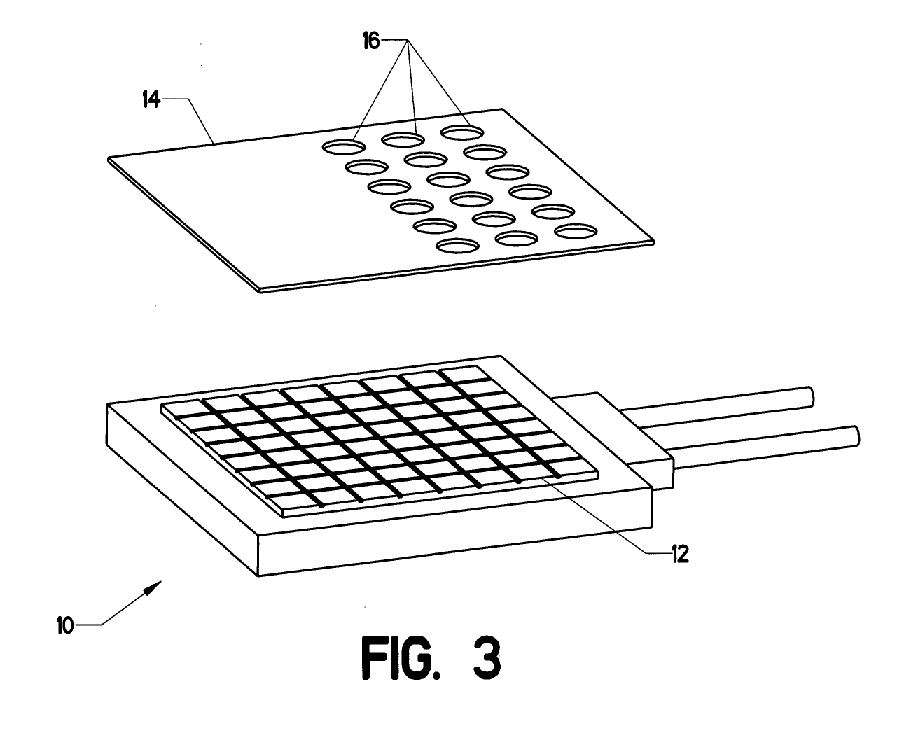

FIG. 3 is a simplified depiction of such an arrangement. The interceding absorber in this arrangement is a neutral density filter 14. One or more perforations 16 are provided in the neutral density filter so that the photon flux is unevenly distributed on pixel array 12. The resulting plot of the SiPM response looks something like Curve C in FIG. 1.

It is immaterial whether the obscured portion of the pixel array is covered by one contiguous sheet of filter or by disjointed pieces. In the example shown, the overall pass fraction is about 0.55, which raises the single pixel threshold to about 1.8 effective photons. In this example the 95% of full level point is reached at 21 effective photons per pixel, a nearly four fold increase in the dynamic range in comparison to the prior art. To reach a comparable dynamic range using the prior art approach would require a SiPM with nearly 4 times more pixels.

The behavior of these two examples is perhaps counterintuitive, but the shapes of Curve B and Curve C are easily understood as weighted sums of the individual pixel probabilities to fire. In other words, if Curve C were the response for a 1,000-pixel SiPM, it behaves as if it were two SiPM's of 500 pixels each with one being unaltered and the other being covered by an interceding absorber (with the output of the two separate arrays being summed). It should also be noted that perfectly uniform incoming illumination is not required for this method to function.

The discussion of all the preceding examples has proceeded as if each pixel can fire only once. In fact, a pixel has a recovery time after which it can fire again. Light pulses which last longer than the recovery time can fire the same pixel more than once. The effect is to alter the response function in the direction of higher response for longer pulses (“flash duration”), resulting in a calibration shift. This is a well-known problem in the use of SiPM's.

The effect is stronger at higher illumination intensities and under some conditions the response “fraction” could exceed unity. However, by judicious optical design using the proposed interceding absorbers, the calibration shift caused by flash duration can be suitably reduced. This is particularly true where the duration and intensity of the light source is predictable.

The reader will thereby understand that the proposed inventive method significantly expands the dynamic range of non-linear detectors such as SiPM's. With little effort and cost, a 5-fold or larger increase in dynamic range is attainable. This method may also allow the mitigation of calibration errors resulting from varying flash duration.

The preceding description contains significant detail regarding the novel aspects of the present invention. It should not be construed, however, as limiting the scope of the invention but rather as providing illustrations of the preferred embodiments of the invention. Accordingly, the scope of the invention should be fixed by the following claims, rather than by the examples given.

Having described my invention, I claim:

1. A method for expanding the dynamic range of a non-linear detector, comprising:
a. providing a photon flux source;
b. providing a non-linear detector, said non-linear detector having an array of pixels connected in parallel, with each of said pixels operating in Geiger mode;
c. wherein said array of pixels is oriented to receive said photon source flux;
d. providing an interceding absorber, said interceding absorber having non-uniform optical transmission; and
e. placing said interceding absorber proximate said array of pixels and between said array of pixels and said photon flux source so that said interceding absorber produces a non-uniform distribution of photons on said array of pixels.

2. A method for expanding the dynamic range of a non-linear detector as recited in claim 1, wherein said interceding absorber is a lens.

3. A method for expanding the dynamic range of a non-linear detector as recited in claim 2, wherein said lens is placed so that it places a focus zone on a portion of said array of pixels and a penumbra on a portion of said array of pixels.

4. A method for expanding the dynamic range of a non-linear detector as recited in claim 2, wherein said lens places about 90% of said photon flux onto about 40% of said pixels in said pixel array.

5. A method for expanding the dynamic range of a non-linear detector as recited in claim 1, wherein said interceding absorber is a filter having a first portion with a relatively high optical transmission and a second portion having a relatively low optical transmission.

6. A method for expanding the dynamic range of a non-linear detector as recited in claim 5, wherein said filter has a pass fraction of about 0.55.

7. A method for expanding the dynamic range of a non-linear detector, comprising:
a. providing a photon flux source;
b. providing a non-linear detector, said non-linear detector having an array of pixels connected in parallel, with each of said pixels operating in Geiger mode;
c. wherein said array of pixels is oriented to receive said photon source flux; and
d. partially blocking the photon flux traveling from said photon flux source to said array of pixels in order to produce a non-uniform distribution of photons on said array of pixels.

8. A method for expanding the dynamic range of a non-linear detector as recited in claim 7, wherein said step of partially blocking said photon flux source is accomplished by placing a lens in said photon flux proximate said array of pixels.

9. A method for expanding the dynamic range of a non-linear detector as recited in claim 8, wherein said lens is placed so that it places a focus zone on a portion of said array of pixels and a penumbra on a portion of said array of pixels.

10. A method for expanding the dynamic range of a non-linear detector as recited in claim 8, wherein said lens places about 90% of said photon flux onto about 40% of said pixels in said pixel array.

11. A method for expanding the dynamic range of a non-linear detector as recited in claim 7, wherein said step of partially blocking said photon flux source is accomplished by placing a filter having a first portion with a relatively high optical transmission and a second portion having a relatively low optical transmission in said photon flux proximate said array of pixels.

12. A method for expanding the dynamic range of a non-linear detector as recited in claim 11, wherein said filter has a pass fraction of about 0.55.

13. A method for expanding the dynamic range of a non-linear detector, comprising:
a. providing a non-linear detector, said non-linear detector having an array of pixels connected in parallel, with each of said pixels operating in Geiger mode;
b. orienting said non-linear detector so that said array of pixels receives a photon source flux from a suitable photon source; and
c. providing an interceding absorber between said array of pixels and said photon source, said interceding absorber having non-uniform optical transmission so that said interceding absorber produces a non-uniform distribution of photons on said array of pixels.

14. A method for expanding the dynamic range of a non-linear detector as recited in claim 13, wherein said interceding absorber is a lens.

15. A method for expanding the dynamic range of a non-linear detector as recited in claim 14, wherein said lens is placed so that it places a focus zone on a portion of said array of pixels and a penumbra on a portion of said array of pixels.

16. A method for expanding the dynamic range of a non-linear detector as recited in claim 14, wherein said lens places about 90% of said photon flux onto about 40% of said pixels in said pixel array.

17. A method for expanding the dynamic range of a non-linear detector as recited in claim 13, wherein said interceding absorber is a filter having a first portion with a relatively high optical transmission and a second portion having a relatively low optical transmission.

18. A method for expanding the dynamic range of a non-linear detector as recited in claim 17, wherein said filter has a pass fraction of about 0.55.

19. A method for expanding the dynamic range of a non-linear detector by rendering the flux of incoming detected objects non-uniform.
